(19) United States
(12) Patent Application Publication
(10) Pub. No.: US 2026/0185597 A1
(43) Pub. Date: Jul. 2, 2026

(54) PLANETARY GEAR WITH IMPROVED BEARING FLANGE

(71) Applicant: Maxon International AG, Sachseln (CH)

(72) Inventors: Florian SCHULER, Ettenheim (DE); Stefan WESTHOLT, Sexau (DE); Dominik FREY, Sexau (DE)

(21) Appl. No.: 18/868,462

(22) PCT Filed: May 26, 2023
(86) PCT No.: PCT/EP2023/064196

§ 371 Date: Nov. 22, 2024

(30) Foreign Application Priority Data
May 27, 2022 (EP) 22175810.5

(51) Int. Cl. F16H 57/021; F16C 19/08; F16C 35/04; F16H 1/46

(52) U.S. Cl. CPC F16H 57/021; F16C 35/045; F16H 1/46; F16C 19/08

(57) ABSTRACT

The planetary gear includes a ring gear, at least one gear stage and a bearing flange for the mounting of an output shaft. The bearing flange is of multi-part design and has at least a first bearing flange part on the ring-gear side and a second bearing flange part on the output side. The first bearing flange part is formed integrally with the ring gear, and the second bearing flange part is designed as a separate component and is connected nonrotatably to the first bearing flange part.

### CROSS-REFERENCE TO RELATED APPLICATION

This application claims priority to and the benefit of PCT Patent Application No. PCT/EP2023/064196, filed May 26, 2023, and entitled “PLANETARY GEAR WITH IMPROVED BEARING FLANGE” and also to European Patent Application No. 22175810.5, filed May 27, 2022, and entitled “PLANETARY GEAR WITH IMPROVED BEARING FLANGE,” the entire contents of these applications being herein incorporated by reference.

### BACKGROUND

### 1. Field of the Invention

The present patent application relates to a planetary gear comprising a ring-gear, at least one gear stage and a bearing flange for supporting an output shaft.

### 2. Related Art

An essential task of such a planetary gear is to ensure a safe bearing of the output shaft of the gear. In particular, radial forces acting on the output shaft must also be absorbed.

WO 2021/075217 A1 teaches an electric motor with a planetary gear attached to it. For this purpose, a motor holder is provided, which is screwed to the electric motor. The ring-gear of the planetary gear is connected to the motor holder via a plug-in connection. On the side of the ring-gear opposite the motor, there is an integrally formed bearing holder that holds a bearing for the output shaft of the planetary gear. The output shaft bearing is fully supported by the bearing holder. There is no contact of the bearing with the ring-gear or the motor mount. The bearing holder is further connected to the planetary gearbox via a plug connection. In addition, the motor mount, the hollow gear wheel and the bearing holder are screwed together by means of several screws.

DE 10 2018 204 051 A1 also shows a geared motor with an electric motor and a planetary gear, which is attached to the electric motor by means of mounting screws. The ring-gear of the planetary gear forms part of the gearbox housing. In addition, the planetary gear comprises a bearing plate that is integrally formed with the ring-gear. The output shaft is supported by two slide bearings, which are mounted in the bearing plate at an axial distance from each other.

From DE 10 2005 052 008 A1 a planetary gear with an input shaft, one or two gear stages and a multi-part housing is known. The housing includes a housing part for mounting an output-side shaft. The input-side shaft includes the sun wheel gearing and is also called the sun wheel. The housing part for mounting the output-side shaft is designed with a first bearing seat for supporting a ring-gear side bearing and a second bearing seat for supporting an output side bearing. Both bearings of the output-side shaft, i.e. both the ring-gear side bearing and the output-side bearing, are thus accommodated in the housing part. The outer ring of the ring-gear side bearing is arranged adjacent to the ring-gear. The housing parts are connected to each other by screws. The screws run in the gearbox housing, between the outside of the housing and the ring-gear toothing. The ring-gear toothing is designed as an internal toothing on the gearbox housing and is in engagement with the planetary gears.

U.S. Pat. No. 5,240,462 A describes another planetary gear. The planetary gear comprises an input shaft on which a sun gear is arranged, a ring-gear, a plurality of planetary gears which mesh with the sun gear and the ring-gear, and a housing. The planetary gears are rotatably mounted on planetary shafts. The planet shafts are connected to a carrier which is integrally formed with an output shaft. The output shaft is rotatably mounted in the housing by means of two bearings. The housing is formed of multiple parts and comprises a side plate, a central flange and a housing cylinder. One of the bearings of the output shaft is mounted in the central flange, while the other bearing of the output shaft is mounted in the side plate. The central flange is screwed to the housing cylinder, in which the ring-gear is also located, by means of screws. The side plate is connected to the central flange by means of screws. The housing cylinder has no contact with the two bearings for supporting the output shaft.

### SUMMARY

The object of the present disclosure is to provide a planetary gear as described above which improves the gears known from the prior art and, in particular, provides a cost-effective and simple to manufacture solution for the output shaft bearing of the gear, regardless of the materials used in the planetary gear.

Accordingly, in a planetary gear comprising a ring-gear, at least one gear stage and a bearing flange for mounting an output shaft, a solution to the above-discussed problem is provided if the bearing flange is designed in multiple parts and comprises at least a first ring-gear side bearing flange part and a second output side bearing flange part, wherein the first ring-gear side bearing flange part is formed integrally with the ring-gear and the second output side bearing flange part is formed as a separate component and is connected in a rotatably fixed manner to the first ring-gear side bearing flange part.

The bearing flange surrounds the bearings provided for supporting the output shaft in the radial direction from the outside or supports the bearings from the inside. The bearing flange of the present disclosure is designed in multiple parts. Preferably, each of the individual bearing flange parts surrounds the bearings provided for mounting the output shaft at least partially in the radial direction from the outside or supports the bearings at least partially from the inside. The first ring-gear side bearing flange part can be designed as an annular disc. The annular disc is adjacent to the ring-gear, for example a cylindrical part of the ring-gear. The second output-side bearing flange part can comprise a same outer contour as the first as the first ring-gear side bearing flange part and can also be designed as a cylinder. The two-part design of the bearing flange ensures that two bearings provided for the output shaft bearing can be arranged at a certain axial distance from each other. This makes it possible to absorb larger radial forces on the output shaft. Due to the two-part or multi-part design of the bearing flange, different materials can be used for the two bearing flange parts. This allows for various material combinations for the two bearing flange parts. This results, inter alia, in cost savings, wherein the two bearing flange parts can be designed more easily according to their different loads and the required force absorption of the two components.

Advantageous embodiments of the present disclosure are the subject of the subclaims.

In a preferred embodiment of the present disclosure, it may be provided that the ring-gear is sintered. Because of the fact, that the ring-gear is made of a sintered material a cost-effective manufacture is possible, while maintaining a high level of precision. To achieve the required precision, the sintered parts must be pressed into a mold under high pressure. This is only possible up to a certain length of the components, which is why sintered metal components can only comprise a limited maximum length. Due to the two-part design of the bearing flange, the ring-gear, which is integrally formed with the first ring-gear side bearing flange part, can be designed to be longer, whereby several planetary gear stages for higher reduction or wider planetary gears for transmitting higher torques can be arranged in the ring-gear. The arrangement of the bearings in the two-part bearing flange enables the output shaft to be supported by means of two bearings arranged at a certain or predetermined axial distance from each other, even in the case of a ring-gear made of sintered material.

Advantageously, it can also be provided, that the first ring-gear side bearing flange part and the second output side bearing flange part are connected to one another in a rotatably fixed manner by means of a screw connection. A screw connection is possible with practically all materials. In particular with sintered components, alternative connection methods such as welding, gluing or pressing are disadvantageous and complex to implement. In addition, a screw connection can be separated and reassembled without leaving any residue.

In order to prevent the screw connection of the two bearing flange parts from coming loose from the outside, at least one through-hole can be formed in the first ring-gear side bearing flange part and at least one blind hole can be formed in the second output-side bearing flange part, which cooperates with the through-hole to accommodate a screw. In an alternative design, the bore in the second output side bearing flange part can also be designed as a through-hole. Thus, the screw connection is not guided in a gearbox housing along the ring-gear, but is arranged at the end of the ring-gear in the first ring-gear side flange part. For the screw connection, the screw is inserted through the through-hole in the ring-gear side bearing flange part and screwed into the blind hole in the second output-side bearing flange part. The screw or screws are therefore oriented from the inside, from the ring-gear side, to the outside, towards the output side. It is not possible to loosen the connection between the two bearing flange parts from the outside when the planetary gear is assembled. Nevertheless, it is optionally possible to disassemble the gearbox and to loosen the screw connection from the inside of the ring-gear in a non-destructive manner. In a simple design of the screw connection, it can preferably also be provided, that the blind hole comprises a thread. Alternatively, it is also possible that the blind hole is designed without a thread. In this case, the screws are self-tapping.

In order to enable secure mounting of the output shaft in the bearing flange, it may also be provided that the bearing flange comprises a first ring-gear side bearing seat and a second output side bearing seat, wherein the first ring-gear side bearing seat and the second output side bearing seat are arranged at a distance from each other in the axial direction of the output shaft. Due to the spacing of the bearings, which are arranged in the two bearing seats, larger radial forces can be absorbed by the output shaft in accordance with the lever principle.

In this case, the first ring-gear side bearing seat is preferably formed in both the first ring-gear side bearing flange part and the second output side bearing flange part. Preferably, the second output side bearing flange part forms a stop for the bearing arranged in the first bearing seat. This makes it easy to compensate for manufacturing tolerances of the two bearing flange parts. The bearing can also be pressed into the bearing seat, whereby the bearing tolerance can be compensated by pressing it to size. The bearing seat on the bearing of the second output-side bearing flange part can have a clearance fit. The first ring-gear side bearing flange part and the second output-side bearing flange part are thus centered relative to one another, when they are brought together, which simplifies the assembly of the two components. Furthermore, easy machining of the bearing seat is possible. Existing manufacturing tolerances of the bearing seat in the first ring-gear side bearing flange part and/or on the second output-side bearing flange part can be reduced by post-processing, such as turning, drilling, milling or grinding.

The second output side bearing seat is preferably formed in the second output side bearing flange part. Since the two bearing seats are formed on two different components, the two bearing flange parts, good machining of the two bearing seats is possible.

In yet another advantageous embodiment, it is provided that a first ring-gear side bearing for the output shaft is arranged on the first ring-gear side bearing seat and a second output-side bearing for the output shaft is arranged on the second output side bearing seat. The first bearing and the second bearing are preferably designed such, that radial forces in particular are absorbed by the second output side bearing. This allows the first ring-gear side bearing to be smaller than the second output side bearing. This makes it possible for the screw connection between the two bearing flange parts to be arranged radially between the first ring-gear side bearing and the ring-gear diameter. In this way, despite the bearing required on the output side and the stronger output shaft caused by the torque, it is possible to find the necessary installation space to provide an additional screw connection even in small gearboxes with a diameter of less than 100 mm.

Preferably, the second output side bearing seat is arranged as far as possible on the axial end opposite the first ring-gear side bearing flange part, in order to achieve the greatest possible distance between the first ring-gear side bearing seat and the second output side bearing seat, and thus between the first ring-gear side bearing and the second output side bearing.

Yet another advantageous embodiment provides that the first ring-gear side bearing comprises a smaller diameter than the second output side bearing. The screw connection can therefore be provided inside the ring-gear, so that the installation space in the outer circumference of the hollow space can be reduced, which in turn allows for a larger ring-gear with a larger reduction ratio.

In a further embodiment, the planetary gear can be designed as a multi-stage gear, wherein the ring-gear covers at least the first two output-side gear stages. A higher reduction ratio can be achieved by means of a multi-stage gear.

In order to achieve a particularly compact design of the planetary gear, the ring-gear can be designed to form part of a gearbox housing.

Preferably, the wall thickness of the ring-gear or of the gearbox housing is less than 20%, preferably less than 15%, and particularly preferably less than 10%, of the outer radius of the gearbox housing. Due to a small wall thickness the gearing diameter of the ring-gear can be as large as possible, which enables a larger gear reduction ratio. A larger gear reduction ratio could also be achieved with additional stages, but this would increase the overall length of the gearbox and reduce the efficiency.

Advantageously, the at least one through-hole in the first ring-gear side bearing flange part can be provided with a step or a chamfer, wherein the through-hole comprises a larger diameter on the ring-gear side. This allows a screw head of the screw to be received axially within the through-hole in the first ring-gear side bearing flange part and to be essentially flush axially with the ring-gear side end face of the bearing flange. This avoids the need for additional installation space for the screw head.

Preferably, a seal is arranged between the first ring-gear side bearing flange part and the second output side bearing flange part. The seal is preferably designed as an O-ring. The seal tightly seals the first ring-gear side bearing flange part and the second output side bearing flange part, which in particular prevents the penetration of liquids or gases between the two parts.

In yet another advantageous embodiment, it may be provided, that the second output side bearing flange part is made of aluminum. This leads to advantages in terms of cost and weight of the planetary gear

In order to obtain a secure connection between the two bearing flange parts, it can be provided that the first ring-gear side bearing flange part and the second output side bearing flange part are screwed together by means of at least four screws, preferably by means of eight screws.

### BRIEF DESCRIPTION OF THE DRAWING

In the following, an embodiment of the present disclosure is explained in more detail with reference to a drawing.

FIG. 1 shows a section through a planetary gear 1 according to the disclosure.

### DETAILED DESCRIPTION OF THE ENABLING EMBODIMENT

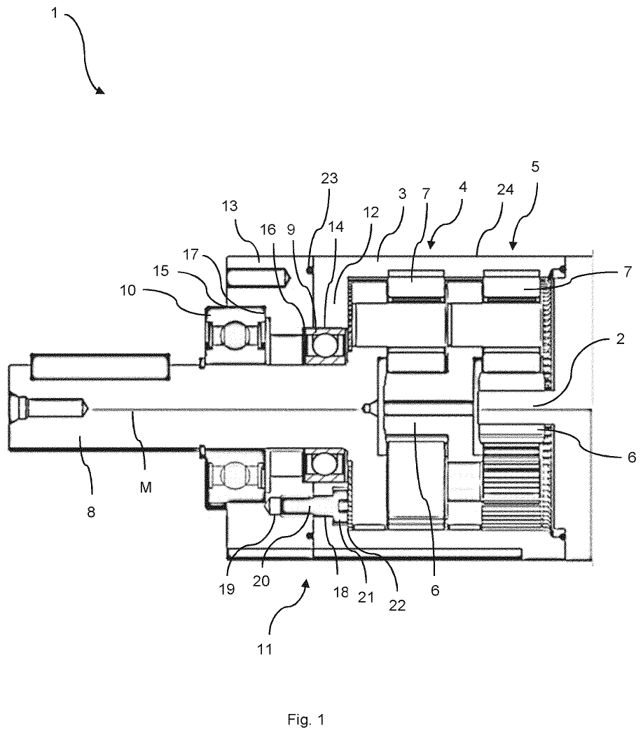

The planetary gear 1 comprises an input shaft 2 and a ring-gear 3, in which a first gear stage 4 and a second gear stage 5 are arranged. Each of the two gear stages 4, 5 comprises a central sun gear 6, which is in engagement with at least one planet gear 7. Each of the planet gears 7 is provided with external teeth that engage with internal teeth of the ring-gear 3. In addition, the planetary gear 1 comprises an output shaft 8. As can be clearly seen in FIG. 1, the ring-gear 3 forms part of a gearbox housing 24.

In FIG. 1 a two-stage planetary gear 1 is shown. It is also possible to design planetary gears as multi-stage planetary gears. In planetary gears with more than two stages, the ring-gear covers at least the first two output-side gear stages. A higher gear reduction can be achieved with a multi-stage gear, although the efficiency of the planetary gear decreases with each stage.

The output shaft 8 is mounted by means of a first ring-gear side bearing 9 and a second output side bearing 10. The two bearings 9, 10 are held in a bearing flange 11. The bearing flange 11 is designed in multiple parts, in the illustrated embodiment in two parts, and comprises a first ring-gear side bearing flange part 12 and a second output side bearing flange part 13. The first ring-gear side bearing flange part 12 is designed integrally with the ring-gear 3. Thus, the ring-gear 3 and the first bearing flange part 12 are integrally designed as a single-piece component. As shown in FIG. 1, the first bearing flange part 12 extends from the peripheral surface of the ring-gear 3 in the direction of a central axis M of the planetary gear 1. The bearing flange part 12 comprises a central recess for receiving the output shaft 8 and the first bearing 9. The second bearing flange part 13 is designed as a separate component. The second output side bearing flange part 13 is preferably made of aluminum.

Two bearing seats 14, 15 are formed in the bearing flange 11, a first ring-gear side bearing seat 14 and a second output side bearing seat 15. The first ring-gear side bearing seat 14 is formed by the first bearing flange part 12, which is integrally formed with the ring-gear 3, and by the second bearing flange part 13. In this case, a first shoulder 16 is formed in the second output side bearing flange part 13, which forms an axial stop for the outer ring of the first ring-gear side bearing 9. The second output side bearing seat 15 is formed in the second output side bearing flange part 13. A second shoulder 17 is formed in the second output side bearing flange part 13, which forms an axial stop for the outer ring of the second output side bearing 10. The two bearings 9, 10 are arranged at an axial distance from each other. This makes it possible to absorb larger radial forces on the output shaft 8.

Preferably, the ring-gear 3, together with the first bearing flange part 12 formed integrally therewith, is made of a sintered material. The ring-gear 3 and the first bearing flange part 12 are therefore sintered, i.e. produced in a sintering process. Sintered metal components can only comprise a limited maximum length. Due to the fact that the bearing flange 11 is designed in multiple parts, in the illustrated embodiment in two parts, with the first ring-gear side bearing flange part 12, which is designed integrally with the ring-gear 3, and the second output side bearing flange part 13, which is designed as a separate component, it is possible to use a sintered ring-gear and still ensure the required axial distance between the two bearing seats 14, 15 formed in the bearing flange 11.

In the illustrated example, the two bearings 9, 10 are designed such, that radial forces in particular are absorbed by the second output side bearing 10. This means that the first ring-gear side bearing 9 can be made smaller and comprises a smaller outer diameter than the second output side bearing 10.

The second output side bearing flange part 13 is connected to the first ring-gear side bearing flange part 12 in a rotatably fixed manner. In the illustrated example, the connection in a rotatably fixed connection is realized by means of a screw connection. For this purpose, the first ring-gear side bearing flange part 12 comprises at least one through-hole 18. At least one blind hole 19 is formed in the second output side bearing flange part 13, which cooperates with the through-hole 18 in the first bearing flange part 12 to receive a screw 20. The advantage of a screw connection is that the screw connection can be separated and reassembled without leaving any residue. In addition, a screw connection is possible with practically all materials. Alternative connection methods such as welding, gluing or pressing are disadvantageous and expensive to implement, especially with sintered components.

The screw connection is preferably created by means of at least four and preferably eight screws. Accordingly, the first bearing flange part 12 comprises at least four, preferably eight through-holes, and the second bearing flange part 12 comprises at least four, preferably eight blind holes, which each interact with one of the through-holes in the first bearing flange part 12 to receive the screws. The screws 20 are therefore oriented from the inside, i.e. from the ring-gear side, to the outside, i.e. towards the output side. The screw connection is therefore not visible or accessible from the outside. This means that it is not possible to loosen the screw connection from the outside when the planetary gear 1 is assembled. However, it is optionally possible to disassemble planetary gear 1 and to loosen the screw connection non-destructively from the inside of the ring-gear.

As described above, the first ring-gear side bearing 9 comprises a smaller diameter than the second output side bearing 10 on the output side. This allows the screw connection to be arranged radially between the first bearing 9 and the ring-gear diameter. This eliminates the need for a screw connection on the outside of the ring-gear 3 or for screws that run axially in the gearbox housing 24. The required installation space of the outer circumference of the ring-gear 3 is thus reduced, which in turn allows for a larger ring-gear with a larger gear reduction ratio. In the embodiment shown in FIG. 1, the wall thickness of the gearbox housing 24 is less than 15%. The wall thickness depends, among other things, on the size of the gearbox housing, the torque to be transmitted and the housing material used.

In the illustrated example, the through-hole 18 in the first ring-gear side bearing flange part 12 is designed with an enlarged diameter. On the output side, the through-hole comprises a smaller diameter. This creates a shoulder in the through-hole 18. This allows a screw head 21 to be accommodated axially within the through-hole 18. The screw head 21 of the screw 20 is therefore essentially flush with the ring-gear side end face 22 of the bearing flange 11 and rests against the shoulder in the through-hole 18. This avoids the need for additional installation space for the screw head 21.

Preferably, the at least one blind hole 19, or each blind hole 19, comprises a thread. Alternatively, the blind hole(s) 19 can also be designed without a thread. In this case, the screw(s) 20 is/are self-tapping.

A seal 23 is preferably arranged in the interface of the two-part bearing flange 11, that is between the first bearing flange part 12 and the second bearing flange part 13. In the illustrated embodiment, the seal 23 is designed as an O-ring.

### LIST OF REFERENCE NUMBERS

1 planetary gear
2 input shaft
3 ring-gear
4 first gear stage
5 second gear stage
6 sun gear
7 planet gear
8 output shaft
9 first ring-gear side bearing
10 second output side bearing
11 bearing flange
12 first ring-gear side bearing flange part
13 second output side bearing flange part
14 first ring-gear side bearing seat
15 second output side bearing seat
16 first shoulder
17 second shoulder
18 through-hole
19 blind hole
20 screw
21 screw head
22 ring-gear side end face of the bearing flange
23 seal
24 gearbox housing
M central axis of the planetary gear

What is claimed is:

1. A planetary gear comprising:
a ring-gear,
at least one gear stage and a bearing flange for mounting an output shaft, wherein the bearing flange is designed in multiple parts and comprises at least a first ring-gear side bearing flange part and a second output side bearing flange part, and
wherein the first ring-gear side bearing flange part is formed integrally with the ring-gear and the second output side bearing flange part is formed as a separate component and is connected in a rotatably fixed manner to the first ring-gear side bearing flange part.

2. The planetary gear according to claim 1, wherein the ring-gear is sintered.

3. The planetary gear according to claim 1, wherein the first ring-gear side bearing flange part and the second output side bearing flange part are connected to one another in a rotatably fixed manner by means of a screw connection.

4. The planetary gear according to claim 1, wherein at least one through-hole is formed in the first ring-gear side bearing flange part and at least one blind hole, that cooperates with the through-hole to receive a screw, is formed in the second output side bearing flange part.

5. The planetary gear according to claim 1, wherein the bearing flange has a first ring-gear side bearing seat and a second output-side bearing seat, wherein the first ring-gear side bearing seat and the second output side bearing seat being arranged at a distance from one another in the axial direction of the output shaft.

6. The planetary gear according to claim 5, wherein the first ring-gear side bearing seat is formed in the first ring-gear side bearing flange part and in the second output side bearing flange part.

7. The planetary gear according to claim 5, wherein the second output side bearing seat is formed in the second output side bearing flange part.

8. The planetary gear according to claim 5, wherein a first ring-gear side bearing for the output shaft is arranged on the first ring-gear side bearing seat and a second output-side bearing for the output shaft is arranged on the second output side bearing seat.

9. The planetary gear according to claim 8, wherein the first ring-gear side bearing comprises a smaller diameter than the second output-side bearing.

10. The planetary gear according to claim 1, wherein the planetary gear is designed with multiple stages and the ring-gear covers at least the first two output-side gear stages.

11. The planetary gear according to claim 1, wherein the ring-gear forms part of a gearbox housing.

12. The planetary gear according to claim 1, wherein the wall thickness of the ring-gear is less than 20% of the outer radius of the gearbox housing.

13. The planetary gear according to claim 4, wherein the at least one through-hole in the first ring-gear side bearing flange part is provided with a step or a chamfer, and wherein the through-hole has a larger diameter on the ring-gear side.

14. The planetary gear according to claim 1, wherein a seal is arranged between the first ring-gear side bearing flange part and the second output side bearing flange part.

15. The planetary gear according to claim 1, wherein the second output side bearing flange part is made of aluminum.

16. The planetary gear according to claim 1, wherein the first ring-gear side bearing flange part and the second output side bearing flange part are screwed together by means of at least four screws.

17. The planetary gear according to claim 12, wherein the wall thickness of the ring-gear is less than 15% of the outer radius of the gearbox housing.

18. The planetary gear according to claim 17, wherein the wall thickness of the ring-gear is less than 10% of the outer radius of the gearbox housing.

19. The planetary gear according to claim 16, wherein the first ring-gear side bearing flange part and the second output side bearing flange part are screwed together by means of at least eight screws.
